(19) United States
(12) Patent Application Publication
(10) Pub. No.: US 2003/0005433 A1
(43) Pub. Date: Jan. 2, 2003

(54) System and method for determining information related to broadcast content

(76) Inventors: Craig M. Janik, Los Altos Hills, CA (US); Nicholas R. Kalayjian, San Francisco, CA (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 10/094,039

(22) Filed: Mar. 7, 2002

Related U.S. Application Data
(60) Provisional application No. 60/274,263, filed on Mar. 8, 2001.
(60) Provisional application No. 60/284,314, filed on Apr. 17, 2001.

(51) Int. Cl. H04N 7/16

(52) U.S. Cl. 725/18

(57) ABSTRACT

A system for determining information related to broadcast content and method for using the same are provided. The system includes a frequency matching device and a tag processing system. The frequency matching device determines a particular frequency of externally tuned audio signals received by an external tuner. The externally tuned audio signals are tagged. A tag message is sent to the tag processing system via a network connection. In one embodiment, the tag message includes the frequency of the external tuner as well as the time and date at the moment that a tag button was activated. The tag processing system finds information related to the externally tuned audio signals by using data in the tag message. The tag processing system finds this information via a wide area network. The tag processing system creates a display of the information related to the externally tuned audio signals.

### NOTICE OF RELATED APPLICATIONS

This application claims the benefit of U.S. Provisional Application No. 60/274,263, filed Mar. 8, 2001, entitled “System and Method for Determining source, Time, and Date of Broadcast Content Source Signals” and 60/284,314, filed Apr. 17, 2001, entitled “System and Method for Determining Source, Time, and Date of Broadcast Content Source Signals”.

### FIELD OF THE INVENTION

The present invention relates generally to ubiquitous computing systems and, more particularly, to determining information related to broadcast content.

### BACKGROUND

Broadcast radio and television mediums have proliferated extensively throughout the world, providing a mass market economical content distribution format. However, one short-coming of broadcast media is its lack of interactivity. With the advent of the Internet and the World Wide Web, many individuals are able to experience content in a narrow-cast format, with inherent interactivity. One advantage of a system with interactivity is the ability to complete a feedback loop that can drive commercial transactions based on a user's interest in the content. Yet much of the most interesting and valuable content is still provided in the broadcast format. The opportunity to interact, or at least to “bookmark” or remember content that is provided in broadcast format is therefore valuable. Products have been introduced that allow a user to “bookmark” or remember a broadcast content program that was experienced. Xenote of San Mateo, California produces a product called iTag. This product is in the form of a key fob, and provides the function of recording a time and date when a button on the iTag is activated by the user. The iTag includes a serial port for connecting it to a Personal Computer for the purpose of downloading the time and date information to the Internet. The iTag is used as follows: A user listens to their favorite radio station, for example in their automobile. When an interesting content item, for example a song, is featured, the user activates the button on the iTag. The iTag device includes an internal microprocessor with a time and date memory function. When the button is activated, the current time and date is written into a memory slot. At some later date, the user connects the iTag to their PC and downloads the time and date listings to a website where each time and date pair is cross-referenced to a lookup table containing the content being played at that time and date on a specific radio station. The iTag requires that the user remember the particular radio station that they were listening to at the time that the button on the iTag was activated, for a specific item of content. Since the iTag can store up to 50 time and date stamps, this presents a challenge for a user who listens to two or more radio stations on a regular basis. In fact, most car stereo head units provide several preset radio station buttons, and many users change radio stations several times per day to avoid advertisements.

Furthermore, the user must remember to connect the iTag to their PC. They must then select the radio station corresponding to a particular time and date stamp on a web site. There is excessive burden placed on the user to remember radio station to which they were listening when the “bookmark” was activated, and additionally, by having to remember to manually dock the iTag device.

### SUMMARY OF THE INVENTION

A system for determining information related to broadcast content and method for using the same are provided. The system includes a frequency matching device and a tag processing system. The frequency matching device determines a particular frequency of externally tuned audio signals received by an external tuner. The externally tuned audio signals are tagged. A tag message is sent to the tag processing system via a network connection. In one embodiment, the tag message includes the frequency of the external tuner as well as the time and date at the moment that a tag button was activated. The tag processing system finds information related to the externally tuned audio signals by using data in the tag message. The tag processing system finds this information via a wide area network. The tag processing system creates a display of the information related to the externally tuned audio signals.

### BRIEF DESCRIPTION OF THE DRAWINGS

FIG. 1 shows a functional block diagram of a system for determining information related to broadcast content.

FIG. 2 shows a functional block diagram of a frequency-matching device.

FIG. 3 shows one embodiment of a schematic of a signal-preprocessing circuit for automatically comparing the signals from an internal radio tuner and external radio tuner.

FIG. 4 shows a flow chart of one embodiment of a method for comparing external radio signal with successively tuned radio signals.

FIG. 5 shows the frequency-matching device of FIG. 2 with a tag button.

FIG. 6 shows one embodiment of AC coupling and signal centering circuits shows a microphone signal input circuit.

FIG. 7 shows one embodiment of a microphone signal input circuit.

### DETAILED DESCRIPTION

Description of Preferred Embodiment

First the components and sub-systems included in the system and method for determining information related to broadcast source signals (also referred to as the disclosed system or frequency-matching system) will be described. Then the operation of the disclosed system will be described.

Definitions

The term “radio tuner” is used to refer to any device that detects, tunes to, and amplifies terrestrially broadcast electromagnetic radio waves for the purpose of producing an audio output signal. Common examples include home stereo systems, car stereo players, and portable radios among others.

Web, world wide web, and Internet are used here interchangeably, and are defined as connected computers, the connection being via standardized digital communications protocols, such as TCP-IP and HTTP and the like, including wirelessly linked devices that may use other protocols.

Broadband connection is defined as a connection to the Internet that provides upstream (sending messages to the Internet) data-rates of approximately 400K or more bits per second, and downstream speeds of approximately 100K or more bits per second. There are many different types of broadband connections including DSL, cable modems, and fixed and mobile wireless connections.

The term gateway, used interchangeably with broadband gateway, is defined as an integral modem and router, and may include hub functionality. The modem function is used to change voltage fluctuations on an input carrier line (a DSL line input or a cable TV input) into digital data. Routers are devices that connect one distinct network to another by passing only certain IP addresses that are targeted for specific networks. Hubs allow one network signal input to be split and thus services many devices.

The term “message” is defined as information that is sent digitally from one computing device to another for the purpose of controlling the functions of devices, and for determining device status. The term “content” is used to mean the information contained in digital files or streams, or analog broadcasts, that is related to end-users. For example, content is entertainment or news, that is, information that was for the most part created by entities other than the end-user. “Data” is used to mean information created by end-users such as digital schedule contents, responses from devices sent back through the system, or digital messages and email. “Content” and “data” are sometimes used interchangeably.

Local Area Network (LAN) is defined as a network structure that includes two or more devices that can communicate with other devices on a shared communication system including wired network technologies, such as Ethernet, or wireless network technologies such as those based on the IEEE 802.11b specification. Wireless LAN technology such as 802.11b are based on the unlicensed 2.4 Ghz frequency band and are well known in the telecommunications and LAN industries. These networking technologies utilize TCP/IP protocols. A LAN typically constitutes a group of interconnected devices that share a physical vicinity. A LAN for example would be a home network where several computers and other smart devices, such as an Internet connected frequency-matching device (described below) would be digitally connected for the purpose of transferring content and data, controlling each other, sharing programming, or presenting data and content to an end user.

HTTP is Hyper-text transfer protocol, the protocol used by Web browsers and Web servers to transfer files, such as text and graphic files.

Description of the Frequency-Matching Device

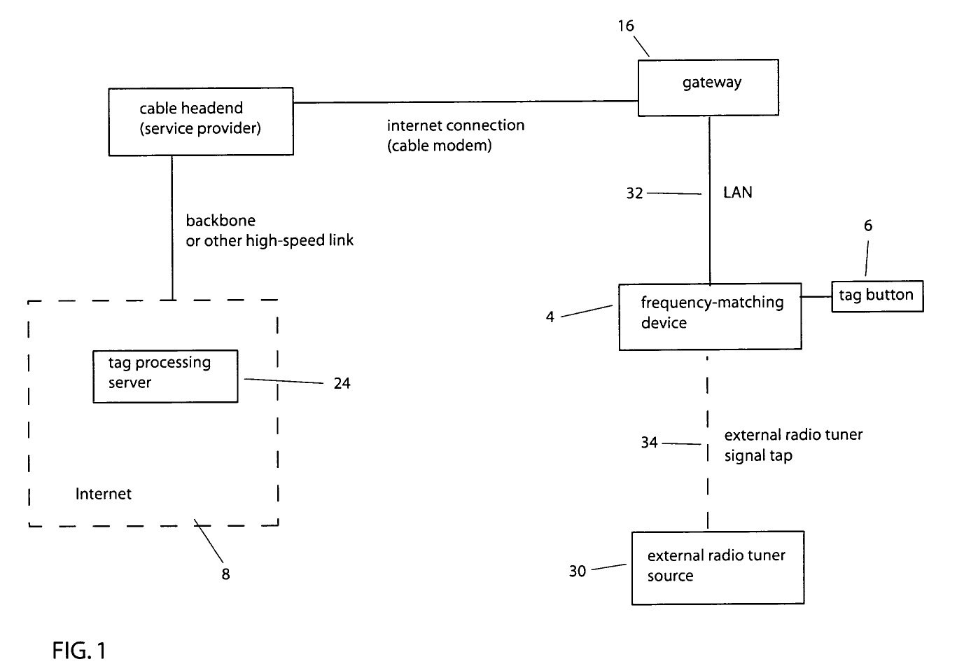

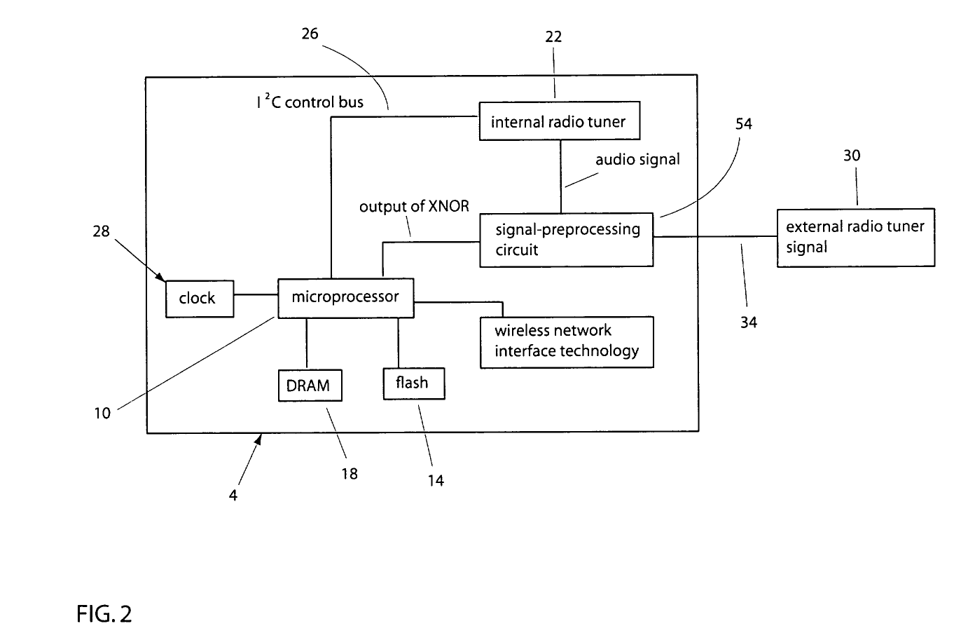

The disclosed system, shown at the system-level in block diagram form in FIG. 1, includes a frequency-matching device 4. Frequency-matching device 4, shown in block diagram form in FIG. 2, is comprised of an embedded computer system, including a microprocessor 10, a non-volatile flash memory 14 for retaining programming (called firmware), a system memory (DRAM) 18 for dynamically executing programming and storing data, and related components associated with embedded computer systems such as discrete logic components, passive electronic components, and the like. Frequency-matching device 4 also includes an internal radio tuner 22 functionally connected to microprocessor 10 via an industry standard control bus, that allows for two-way communication between microprocessor 10 and internal radio tuner 22. In one embodiment, the control bus is the I²C control bus 26, shown in FIG. 2. The specification as well as components for I²C control bus 26 are available from Philips N.V.

Using control bus 26, microprocessor 10 can control the frequency to which the internal radio tuner 22 is tuned. The frequency that internal radio tuner 22 is tuned to is available as digital data to microprocessor 10, and can be stored in memory 18. Internal radio tuner 22 also outputs the analog audio component of the tuned broadcast signal, which is the internal tuned audio signal. Internal radio tuner 22 may be conventional AM/ FM radio tuner on a chip system that detects and amplifies broadcast electromagnetic waves at specific frequencies. Internal radio tuner 22 includes a phase-locked loop (PLL) system, which is a function that allows it to determine when it is tuned to a terrestrial broadcast signal that is of significant strength, and lock on to that signal. An example of such a chip is the TDA7421 AM/FM Tuner for Car Radio and Hi-Fi Applications, manufactured by ST Microelectronics of Saint Genis-Pouilly, France.

Frequcncy-Matching Device LAN Connection to Gateway and Internet

Frequency-matching device 4 also includes a connection to the Internet 8. In one embodiment, this connection is comprised of an 802.11b wireless LAN 32 connection that connects to a gateway 16 with an integral 802.11b network interface adapter. FIG. 1 shows a block diagram of the topography of the system. It should be noted that frequency-matching device 4 is capable of sending XML messages using TCP/IP protocols, to servers on Internet 8, via wireless LAN 32 connection and gateway 16. Firmware instructions in frequency-matching device 4 control this function. The information that frequency-matching device 4 needs to send messages to the server on Internet 8, such as IP addresses and port numbers, is sent to frequency-matching device 4 from Internet 8 when frequency-matching device 4 is initially booted.

Frequency-Matching Device Clock Sub-System

In one embodiment, frequency-matching device 4 also includes a clock sub-system 28 that provides the current time and date to microprocessor 10, to be stored in memory 18. Clock sub-system 28 functions by receiving an initial time and date input from an external source, such as a time reference web server on Internet 8, via gateway 16 with wireless LAN 32 connection, and thereafter accurately increments the time and date with its own internal timing circuit.

Tag Button and Function

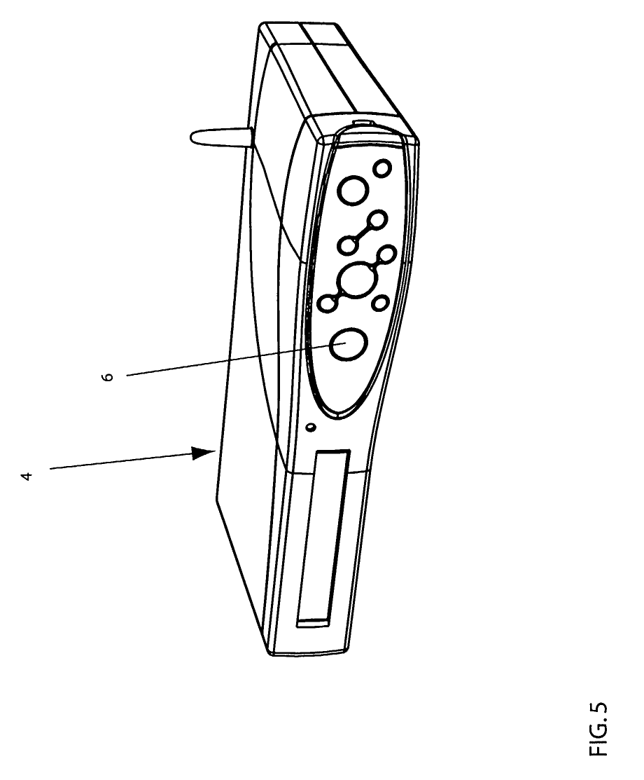

As shown in FIG. 5, frequency-matching device 4 includes a tag button 6 that is an interface control element for the end-user. Tag button 4 is an electrical switch that is connected to a port on microprocessor 10. As part of its function, microprocessor 10 continually monitors that port for a change in voltage that occurs if tag button 6 is activated by the end-user. For example, in a non-activated state, there is a logic low voltage level at tag button 6 port. When the user activates tag button 6, microprocessor 10 becomes aware of a logic high voltage.

External Tuner Signal Input Into Frequency-Matching Device

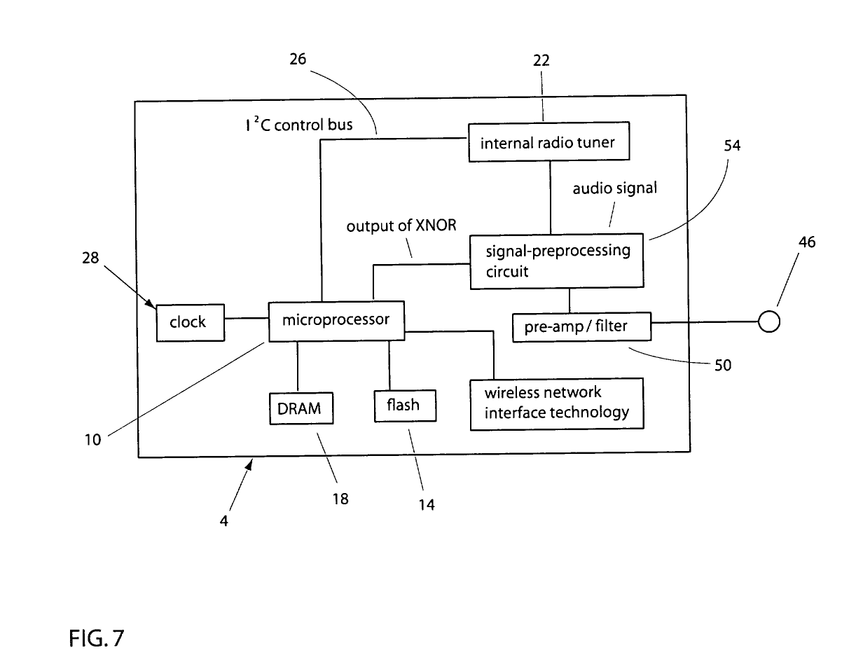

The output of the external radio tuner 30, the external tuned audio signal, is connected to the input of frequency-matching device 4 signal-preprocessing circuit 54 by an external radio tuner signal tap 34. External radio tuner signal tap 34 is a cable that connects at one end to a tuner system signal output port, such as the left and right tape monitor out jacks that are included on most stereo receivers. At this end external radio tuner signal tap 34 has connectors that connect to the RCA-type jacks, but allow the external tuned audio signal to pass through so that the connectors can still be used by other devices. The other end of external radio tuner signal tap 34 cable is connected to a jack included in frequency-matching device 4 that connect external tuned audio signal through to signal-preprocessing circuit 54 (described below). FIG. 7 shows an alternative method for accessing the external tuned audio signal that utilizes a sub-system that is a microphone 46 connected to a pre-amplifier 50, the output of which in turn is connected to the external tuned audio signal input on signal-preprocessing circuit 54. Microphone transducer 46 is located on the outer surface of frequency-matching device 4 enclosure, so that it is in the presence of ambient sound. The ambient sound that is potentially an amplified broadcast radio signal, picked up by microphone 46, is the signal that is input into the external tuned audio signal input.

Signal Pre-Processing Circuit

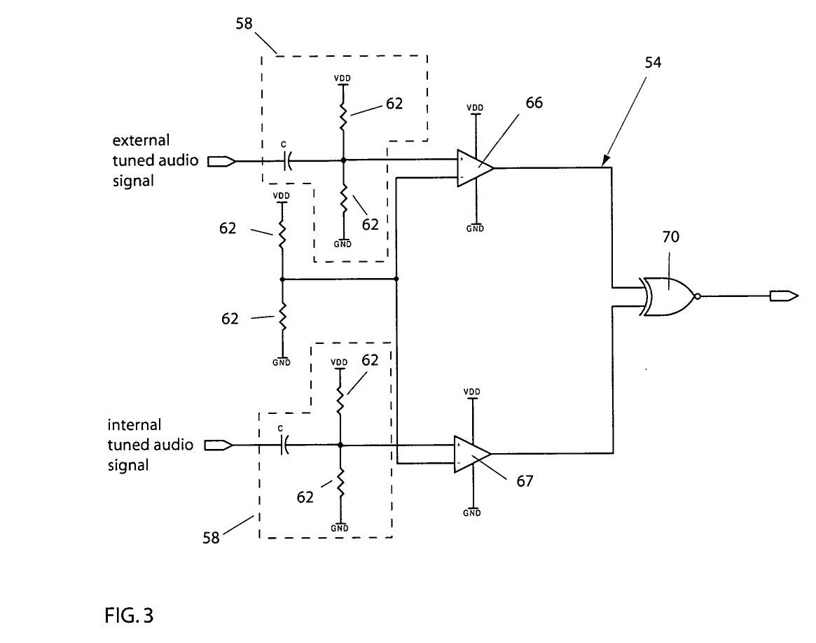

Signal-preprocessing circuit 54 is part of frequency-matching device 4 as shown in FIG. 2. Referring now to FIG. 3, a detail of signal-preprocessing circuit 54, the internal tuned audio signal from internal radio tuner 22 and the external tuned audio signal from external radio tuner 30 are each connected to a separate AC (alternating current) coupling and signal centering circuit. The AC coupling circuit 58 insures that both the internal tuned audio signal and the external tuned audio signal are centered on the same reference voltage with no DC component to the signal. That is, if the external tune audio signal and the external tuned audio signal are the same, both signals will cross the reference voltage at the same time, regardless of gain (signal amplitude) differences. The values of each resistor (R) shown in the schematic are the same. The pre-processed internal tuned audio signal and the pre-processed external tuned audio signal are then connected to the signal inputs of the two non-inverting comparators 66 and 67. Non-inverting comparators 66 and 67 share the reference voltage, also shown in FIG. 2. Non-inverting comparators 66 and 67, such as part number LMC6762, manufactured by National Semiconductor of Sunnyvale, Calif., are electronic devices that compare a signal voltage with a reference voltage. If the signal voltage is lower than the reference voltage, the output of the non-inverting comparator will be a logic low voltage (0 volts). If the signal voltage is greater than the reference voltage, then the output of the non-inverting comparator voltage will be a logic high (5 volts is commonly used). Comparators and their arrangement with the other components shown here are well known in the electronic device industry.

The output of non-inverting comparators 66 and 67 are each connected to an input to a logical exclusive NOR gate 70 device. An example of an exclusive NOR gate 70 device is part number MC14077, manufactured by On Semiconductor of Phoenix, Ariz. The exclusive NOR gate 70 device functions such that if the two inputs into the exclusive NOR gate 70 device are the same voltage (logic) level (within some small tolerance), the output of the exclusive NOR gate 70 device is a logical high. If the voltage (logic) levels of the inputs into the exclusive NOR gate 70 device are different (within some small tolerance), the output of the exclusive NOR gate 70 device will be a logic low signal. Therefore, this circuit functions such that if the external tuned audio signal and the internal tuned audio signal are the same, then they have the same frequency (within some minute phase shift tolerance) and the outputs of comparators 66 and 67 will be the same because the internal tuned audio signal and the external tuned audio signal will be above or below the reference voltage at the same time. In this case, the exclusive NOR gate 70 device will substantially and continually register a logic high.

If the external tuned audio signal and the internal tuned audio signal are different, (i.e., the two radio tuners are tuned to different broadcast radio stations), then they have different frequencies and the outputs of the two comparators will mostly differ over time. When they are different, the exclusive NOR gate 70 device will register a logic low.

Signal Match Duty-Cycle Monitor

The output of signal-preprocessing circuit 54 is connected to a port on microprocessor 10 called the signal match port. Firmware instructions cause the microprocessor to regularly read the value of the logic level at the signal match port, in coordination with the control of internal radio tuner 22. Microprocessor 10 sample rate at the signal match port is very high, for example, sampling once every milli-second, or 1000 times per second. The percentage of the time that the signal is high is the signal match duty-cycle. A large value, such as 75% (the signal is high 75% of the time), for the signal match duty-cycle, indicates that the external tuned audio signal is the same frequency as the internal tuned audio signal. Likewise, a low value such as 20% for the signal match duty-cycle indicates that the internal tuned audio signal and the external tuned audio signal differ in frequency.

Operation of Frequency-Matching System

Next the operation of frequency matching device 4 and system is described including a frequency-matching function and a tag-processing function.

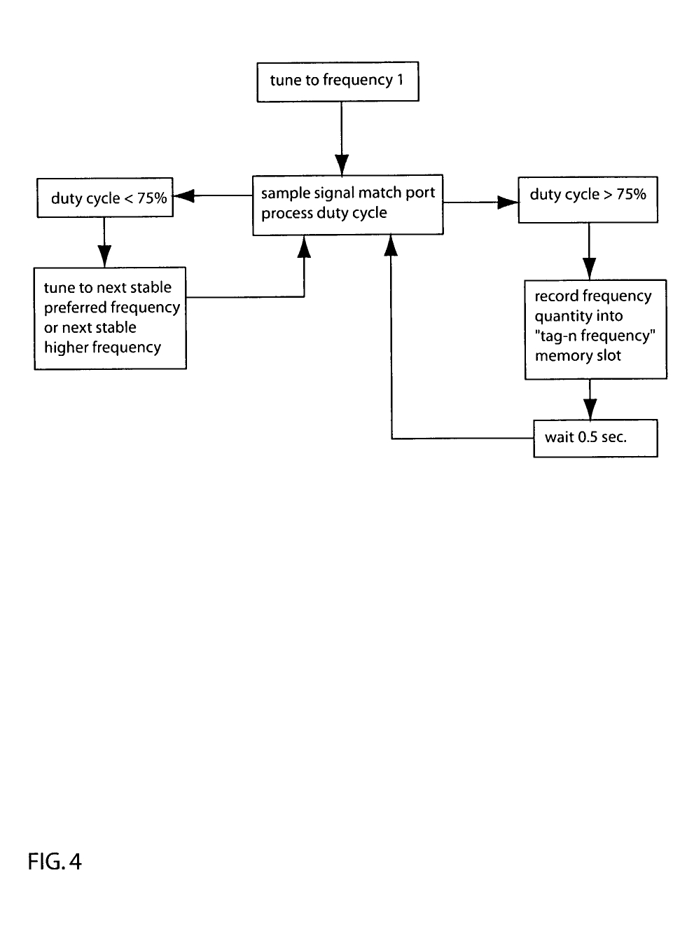

One function of frequency-matching device 4 is to derive the frequency that external radio tuner 30 is currently tuned to. FIG. 4 shows the flow of operations. After booting, according to firmware instructions, microprocessor 10 instructs internal AM/FM tuner 22 to tune to frequency 1. Frequency 1 is a special location in memory 14 that holds a value for a radio broadcast frequency. In one case, for the definition of frequency 1, the first time that frequency-matching device 4 is powered on (or if frequency-matching device 4 has never discovered a frequency-match), frequency 1 is the lowest frequency broadcast signal that internal radio tuner 22 can lock onto. For example, in the U.S., FM commercial broadcast radio signals range between 88.0 and 108.0 Mhz. AM commercial broadcast radio signals range between 540 and 1600 Khz. In the initial state, microprocessor 10 instructs internal radio tuner 22 to tune to the lowest frequency on the FM band, for example 80 Mhz. If internal radio tuner 22 determines that there is no significant signal strength at this frequency, firmware instructs internal radio tuner to tune incrementally up the band until it receives a signal of significant strength. This typically means that there is a local radio station broadcasting at this frequency. Internal radio tuner 22 signals microprocessor 10 that it has locked onto a broadcasting radio station. Microprocessor 10 then samples the signal-match duty cycle port. The process for determining if there is a match is described above. As shown in FIG. 4, if there is a match, the frequency value is written into the flash memory 14. The time and date are also immediately recorded into memory 14 at this point, for the purpose of defining preferred stations, a function disclosed below. In this state where a match has been found, firmware instructions cause microprocessor 10 to re-sample the signal match duty cycle port every half-second until a match is no longer found. If a match is not found, frequency-matching device 4 instructs internal radio tuner 22 to tune to another broadcast signal, either from a preferred list (described below), or the next higher frequency broadcast radio signal that internal radio tuner 22 can lock onto.

Microprocessor 10 must sample the signal match duty cycle for only a fraction of a second to determine if a match exists. Therefore, the process of scanning and analyzing radio signals in order to derive the frequency of the external tuned audio signal may take a few seconds.

Frequencies and Scan Sequence

Frequency-matching device 4 also stores the frequency of the last matched frequency, and when the device is powered on, this frequency is set as frequency 1. The system records in memory 14 the most tuned-to frequencies (radio stations), in order of length of time that the user has listened to those frequencies. For example, the system stores the top ten preferred stations. Microprocessor 10 stores in memory 14 a record of the time when a specific signal match occurred, and the time when the signal match ended, using internal clock 28 function to time-stamp these events. Frequency-match frequencies are then stored in memory 14 in order of the length of time that the frequency-match was sustained. For example, the frequency-match with the longest sustained match time is stored as the first frequency to be scanned (after frequency 1). As frequency-matching device 4 is used over time, the list of preferred radio stations increases. When the frequency-matching device is powered on, if there is no match at frequency 1, then microprocessor 10 instructs internal radio tuner 22 to sequentially tune to frequencies in the preferred frequency list one by one until a match is found. If no match is found, microprocessor 10 instructs internal radio tuner 22 to start at the lowest tunable frequency and sequentially tune to higher frequencies until a match is found. This process is described above in detail. Frequency-matching device 4 will scan through the FM broadcast spectrum and if no match is found it will then scan through the AM broadcast spectrum. Frequency-matching device 4 continues to search for a frequency-match until a frequency-match is found, or until the device is powered off. By tuning to frequencies in a preferred list of frequencies created from practice, the time it takes for frequency-matching device 4 to find the frequency-match value is reduced.

User-Level Function—Tag Processing Function

FIG. 5 shows the frequency-matching device with tag button 6 on the front bezel. Tag button 6 is used for identifying or tagging audio content being played on external radio tuner 30 device. When tag button 6 is activated by a user, assuming that a frequency match has occurred within the system as described above, an XML message, the tag message, is created and sent to a tag-processing server 24 on Internet 8, via LAN 32 and gateway 16 shown in FIG. 1. The XML tag message includes the current frequency-match frequency value, the time and date from the clock, and a unique serial number for frequency-matching device 4. The information in the tag message is then used by a tag processing software application running on tag-processing server 24 located on Internet 8, to derive the content that was being played on external radio tuner 30 when the tag button was activated.

In order to access responses to tagged content, the user has established an account on tag processing server 24 and has provided information including the user's zip code. The user account sub-system is a functional aspect of tag processing software application. The user-also provides the unique serial number for frequency-matching device 4 at the web account. Since frequency matching device 4 is located on user's LAN 32, the operation of providing the tag processing software application with a unique serial number for frequency-matching device 4 could be automated. When a tag-message is received at tag-processing server, tag processing software application at the server matches frequency-matching device's unique serial number with the user's account information, and can therefore establish the geographic location by use of the user's zip code. The tag-processing server software application has access to a zip code-radio frequency database that includes all of the zip codes in the U.S. cross-referenced with radio stations and their broadcast frequencies whose broadcasts reach the zip code areas. Tag processing software application compares the frequency-match value included in the tag message with the radio station broadcast frequencies associated with the user's zip code area until a match is found. When the tagged broadcast radio station has been identified using the above process, a broadcast content playlist is obtained for the specific broadcast radio station. This playlist is a listing of content that was broadcast on a specific date and time. Broadcast content playlists are available from at least two firms, BDS, Inc. (Broadcast Data Systems) of Kansas City, Mo., and MediaBase, Inc. of Sherman Oaks, Calif. Using a patented computer technology, BDS monitors radio and television broadcasts, identifying songs and commercials as they are being aired, and provides playlist data for a fee. Mediabase currently monitors more than 800 radio stations in 125 markets, 24 hours a day, 7 days a week. Additionally, firms can track daily airplay activity on a subscription basis via Mediabase.

The date and time included in the tag-message is cross-referenced with the date and time in the broadcast content playlist for a specific radio broadcast station, and the broadcast content description is produced. The broadcast content description may be a text description of the broadcast content that was playing at the time when the user activated the tag button. The broadcast content description is then posted to the user's private tag list web page that is accessible by the user. Using this method, specific content can be identified that was terrestrially broadcast, tuned to, and played on user's external radio tuner 30 at the time the user activated tag button 6 on frequency-matching device 4. The user can then access their private tag list web page and obtain the information about the content.

In one embodiment, the user connects the output signal from external radio tuner 30 to frequency-matching device 4. In this example, the user has connected their home stereo tape monitor output to frequency-matching device 4 as specified above. The user also sets up frequency-matching device 4 on user's home LAN 32 that is connected to gateway 16 that provides access to Internet 8. While listening to a broadcast radio program on external radio tuner 30, the user identifies a song that he likes, but is unaware of its title. The user pushes tag button 6 on frequency matching device 4 in order to tag that song. In a few moments, the user can access his personal tag list web page using a browser on a PC with a connection to Internet 8 and obtain information about the song that was being played when the user activated tag button 6.

The information included on a tag list web page may include song name, CD name, discography, lyrics, links to other web sites that feature that artist, artist background and history, concert schedule, links to e-commerce sites to purchase CDs or MP3s by that artist, and links to other artist web sites who are included in the same genre of music as the tagged artist.

One Embodiment-Implementation in an Automobile

In one implementation, the car includes the frequency-matching device and a wireless LAN transceiver. When the car comes within range of the home wireless LAN, a connection between the car frequency-matching device and the home gateway is established. In this case, when the user activates the tag button while out of range of the home wireless LAN, the frequency-match value and the time and date are stored but not immediately downloaded to the Internet. However, the tag message is downloaded immediately after the car has established a connection to the home LAN.

In another implementation, the frequency-matching device is connected to a Wide Area Network (WAN) transceiver, such as a cellular phone system. In this case, when the user activates the tag button, the tag message is constructed and a connection is established between the cellular transceiver and a wireless cell. The tag message is then immediately sent through the cellular system to the tag-processing server on the Internet.

Alternative Embodiment: Digital Signal Comparison in Firmware

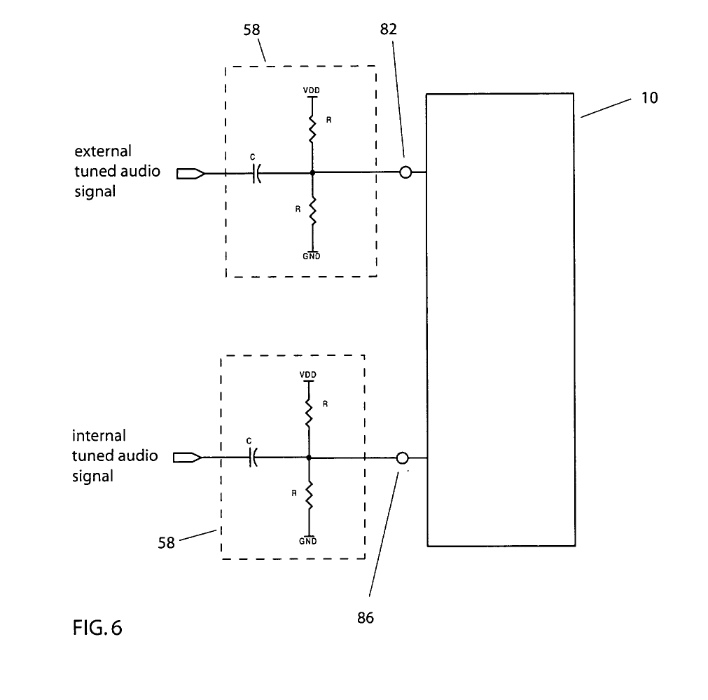

A comparison between the internal and external radio signals is achieved through the use of a signal comparison algorithm executed in firmware on the microcontroller. FIG. 6 shows that both internal and external tuned audio signals are pre-processed with an AC coupling circuit voltage divider circuit. The AC coupling circuit removes the DC component of the signals, and the voltage divider circuit centers the signals on a voltage between VDD and ground (GND). Both pre-processed signals are then connected to two analog-to-digital (A/D) converters, A/D converter A 82 and A/D converter B 86, on the microcontroller 10 that convert the analog radio signal amplitude at an instant, into discrete digitized numbers. Each of the internal tuned audio signal and the external tuned audio radio signal are sampled several times during a fixed period of time (e.g. 1000 samples over 100 milli-seconds) and the digitized amplitude, values are stored in memory as paired data in two arrays. The following is a listing of software source code using the C programming language, for a digital signal comparison algorithm for determining if the external tuned audio signal and internal tuned audio signal are the same:

#define NUMBER_OF_SAMPLES 1000/*settings the number of samples*/

#define MATCH_THRESHOLD 500/*threshold for a positive or negative match*/

main ()
{

| | |
|---|---|
| int Sample_I[num_samples]; | /* declare array to hold internal radio samples */ |
| int Sample_E[num_samples]; | /* declare array to hold external radio samples */ |

| | |
|---|---|
| long I_DC = 0; | /* Average value of internal radio samples */ |
| long E_DC = 0; | /* Average value of external radio samples */ |
| long i; | |

/******* Calculate the average values of each array of samples *******/
for (i = 0; i <NUMBER_OF_SAMPLES; i ++)

| { | |
|---|---|
| I_DC + = Sample_I[i]; | |
| E_DC + = Sample_E[i]; | |
| } | |
| I_DC = I_DC >> NUMBER_OF_SAMPLES; | /* divide using bit-shift */ |

| | |
|---|---|
| E_DC = E_DC >> NUMBER_OF_SAMPLES; | /* divide using bit-shift */ |

/* Calculate the match variable - a higher number indicates that the internal radio signal
is the same signal as the external radio signal */
for (i = 0; i < NUMBER_OF_SAMPLES; i ++)

{
if (Sample_I[i] > I_DC && Sample_E[i] > E_DC)

match ++;

else

if (Sample_I[i] < I_DC && Sample_E < E_DC)

match ++;

else

if match != 0;
match −−;

}

/********** set the match variable based on match threshold ************/
if (match < MATCH_THRESHOLD)

match = 0;

else

match = 1;

}

This algorithm works by first calculating an average for each of the external tuned audio signal array of values and the internal radio signal array of values. Next, each value in each array is determined to be greater or lesser than the respective array average values. If the internal tuned audio signal array value and the external tuned audio signal array value are both simultaneously above or below their respective array averages, then it is assumed that the signals at that sample point are the same and a “match” value is incremented. After both arrays are processed in this way, if a majority of array values are similar in terms of being above or below the respective array average values, then the “match” variable will be incremented a large number of times. If a majority of array values are dis-similar in terms of being above or below the respective array averages, then the “match” variable will be decremented, unless it is already zero. If the “match” variable has been incremented over 750 times, then the “match” variable is given a logic 1 designation.

The theoretical maximum value of the “match” variable is NUMBER_OF_SAMPLES, in this case, 1024. This number is used because it makes the divide function a bit-shift which requires far fewer processor cycles to execute. If the signals are identical, then the “match” variable will be incremented at each cycle of the comparison “for” loop. In practice, there may be a slight phase shift between the internal radio signal and the external radio signal due to differences in tuner circuitry in each radio. The last “if” conditional in the source code listing functions as a digital threshold filter for a match versus no-match decision. This threshold value is determined empirically through testing.

There are many firmware algorithms that can be used to check if two digital signal waveforms are similar, and the above-mentioned algorithm should be regarded merely as an example of one such algorithm.

Alternative Embodiments—Tagging TV Content

The frequency-matching device could also be implemented with an internal TV broadcast tuner in addition to or in place of the internal radio broadcast tuner. Thus terrestrial broadcast TV can be frequency-matched and tagged. The frequency-match device would only process the audio portions of the external TV broadcast tuner signal (the TV) and the internal TV broadcast tuner signal. The TV playlist is thus available to the tag-processing server application that cross-references the frequency-match value and the zip code. The rest of the process is the same as described above.

In another embodiment, the closed-captioning text signal that is combined in many TV broadcast signals could be used to match TV signals. This method would require minimal microprocessor cycles because the system is processing ASCII character text rather than working on an analog to digital conversion. The closed-caption system is similar in function to those described above except that the two text streams are compared rather than the audio signal.

A system and method for determining information related to broadcast content have been provided. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method for receiving information related to a specific broadcast content item, comprising:
having an external tuner receiving an externally turned audio signal at a particular frequency;
determining the particular frequency;
tagging the externally tuned audio signal;
sending a tag message to a tag processing system via a network connection.

2. The method of claim 1 further comprising:
receiving the tag message;
finding information related to the externally tuned audio signal by using data in the tag message, wherein the information is found via a wide area network; and
creating a display with the information.

3. The method of claim 1 wherein the externally tuned audio signal is a radio signal and the external tuner is an automobile radio tuner.

4. The method of claim 1 wherein the tag messages comprises at least one of a radio frequency, a time, and a date.

5. The method of claim 1 wherein the externally tuned audio signal is television signal.

6. The method of claim 1 wherein the network connection is a wireless local area network connection.

7. The method of claim 2 wherein the wide area network is Internet.

8. The method of claim 7 wherein the display is a web page.

9. A content tagging system comprising, in combination:
a frequency matching device connected to determine a particular frequency of an externally tuned audio signal, the frequency matching device comprising a tag button for tagging the externally tuned audio signal; and
a tag processing system to receive the tag message and to find information related to the externally tuned audio signal by using data in the tag message, wherein the information is found via a wide area network, and wherein the frequency matching device and tag processing system connected to a network.

10. The content tagging system of claim 9 wherein the frequency matching system comprises:
a microprocessor;
an internal tuner to provide an internal tuned audio signal;
an external tuner to provide the external tuned audio signal;
a signal pre-processing circuit to compare the internal tuned audio signal and external tuned audio signal to produce an output comprising at least one of a logic high output and a logic low output, the circuit producing the logic high output when the internal tuned audio signal is the same as the external tuned audio signal, and the circuit producing the logic low output when the internal tuned signal is different from the external tuned audio signal, the output of signal preprocessing circuit being input into the microprocessor; and
a frequency matching module on the microprocessor to determine the frequency of the external tuned audio signal based on the state of the output of the signal preprocessing circuit.

11. The content tagging system of claim 9 wherein the tag processing system comprises a tag processing application to receive the tag message from the microprocessor and find the information related to the externally tuned audio signal via the wide area network.

12. The content tagging system of claim 9 wherein the externally tuned audio signal is a radio signal and the external tuner is an automobile radio tuner.

13. The content tagging system of claim 12 wherein the tag messages comprises at least one of a radio frequency, a time, and a date.

14. The content tagging system of claim 9 wherein the externally tuned audio signal is television signal.

15. The content tagging system of claim 9 wherein the network is a wireless local area network.

16. The content tagging system of claim 9 wherein the wide area network is Internet.

17. A frequency matching device comprises:
a microprocessor;
an internal tuner to provide an internal tuned audio signal;
an external tuner to provide the external tuned audio signal;
a signal pre-processing circuit to compare the internal tuned audio signal and external tuned audio signal to produce an output comprising at least one of a logic high output and a logic low output, the circuit producing the logic high output when the internal tuned audio signal is the same as the external tuned audio signal, and the circuit producing the logic low output when the internal tuned signal is different from the external tuned audio signal, the output of signal preprocessing circuit being input into the microprocessor; and
a frequency matching module on the microprocessor to determine the frequency of the external tuned audio signal based on the state of the output of the signal preprocessing circuit.

18. The frequency matching device of claim 17 wherein the externally tuned audio signal is a radio signal and the external tuner is an automobile radio tuner.

19. A computer-readable medium having computer-executable instructions for receiving information related to a specific broadcast content item, comprising:
having an external tuner receiving an externally turned audio signal at a particular frequency;
determining the particular frequency;
tagging the externally tuned audio signal;
sending a tag message to a tag processing system via a network connection.

20. The computer-readable medium of claim 19 having further computer-executable instructions comprising:
receiving the tag message;
finding information related to the externally tuned audio signal by using data in the tag message, wherein the information is found via a wide area network; and
creating a display with the information.
